(19) United States
(12) Patent Application Publication
(10) Pub. No.: US 2010/0218077 A1
(43) Pub. Date: Aug. 26, 2010

(54) MODIFYING A MARKUP LANGUAGE DOCUMENT WHICH INCLUDES A CLICKABLE IMAGE

(76) Inventor: Per HEDBOR, Linkoping (SE)

Correspondence Address: BIRCH STEWART KOLASCH & BIRCH, PO BOX 747, FALLS CHURCH, VA, 22040-0747, US

(21) Appl. No.: 12/710,217

(22) Filed: Feb. 22, 2010

Related U.S. Application Data
(63) Continuation of application No. 11/517,524, filed on Sep. 8, 2006, now abandoned.

(51) Int. Cl. G06F 17/00

(52) U.S. Cl. 715/205; 715/255

(57) ABSTRACT

The invention relates to a method, a computer program product and a computer device for modifying a markup language document which includes a clickable image. The method comprises the steps of extracting a clickable portion of the clickable image, generating a reduced image corresponding to the extracted portion, adding a link element to the reduced image, the link element having an address corresponding to the link address of the clickable portion, and inserting the reduced image into the document. The method may be performed by a transcoding server, a client terminal or a web server operating in a computer network.

### FIELD OF THE INVENTION

The present invention relates in general to information processing. More specifically, the invention relates to a method for modifying a markup language document which includes a clickable image. The invention also relates to a computer program product and a computer device which involves the performing of such a method.

### BACKGROUND OF THE INVENTION

An image map is a markup language document which includes at least one clickable image portion.

Rendering a large image map on a small or low resolution display, e.g. on a mobile telephone, a gaming console, or a television which includes a web browser client, leads to certain problems. If the image map is downscaled, it will be hard for the user to locate and distinguish the clickable portions of the total image.

### SUMMARY OF THE INVENTION

The invention is defined by the appended claims.

Additional features and principles of the present invention will be recognized from the detailed description below.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate an embodiment of the invention. In the drawings,

FIG. 1 is an exemplary block diagram illustrating an embodiment of a system wherein the invention may be used,

FIG. 2 is an exemplary block diagram illustrating a transcoding server in accordance with the invention,

FIG. 3 is an exemplary flow chart illustrating an embodiment of a method in accordance with the invention,

FIG. 4 is an exemplary flow chart illustrating an embodiment of a method in accordance with the invention,

FIG. 5 is an exemplary screenshot, showing a markup language document as viewed on a regular terminal, without modification, and

FIG. 6 is an exemplary screenshot, showing the same markup language document as viewed on a small screen terminal subsequent to a modification in accordance with the invention.

### DETAILED DESCRIPTION OF THE INVENTION

Reference will now be made in detail to the present invention, examples of which are illustrated in the accompanying drawings. Wherever possible, the same reference numbers will be used throughout the drawings to refer to the same or like parts.

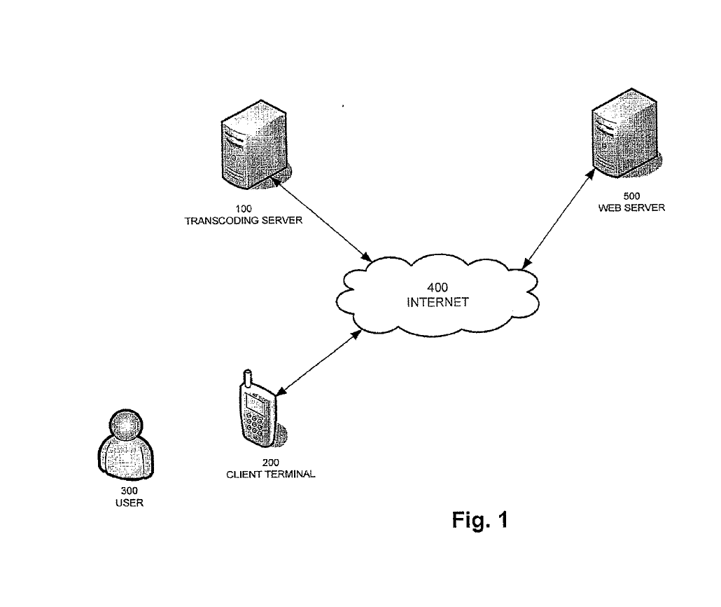

FIG. 1 is an exemplary block diagram illustrating an embodiment of a system in accordance with the invention.

A client terminal 200 is operated by a user 300. The client terminal 200 may be a mobile communication terminal, such as a mobile telephone, equipped with a Java-based microbrowser application, but in the principles of the invention may be implemented on a wide range of different terminals running a browser application. The terminal 200 is operatively connected to the proxy server or transcoding server 100 via the communication network 400.

The transcoding server is arranged to fetch web content, such as HTML pages from other web servers, e.g. the web server 500, connected to the communication network 400. The transcoding server is further arranged to process the fetched content in such a way that it is modified or reformatted in order to be appropriately rendered on the mobile client terminal 100.

In particular, the communication network 400 is arranged for providing wireless mobile communication with the client terminal 200. The network 400 is also arranged for providing communication with the transcoding server 100 and the web server 500. The network 400 may thus typically comprise both the Internet and a wireless communication subnetwork. The wireless subnetwork is, e.g., a mobile communication network such as a GSM network, or alternatively a GPRS, UMTS/3G, CDMA, or PCS network, or alternatively a local wireless network such as a WLAN. The network 400 also comprises gateways necessary in order to provide intercommunication between the Internet and the wireless subnetwork.

The client terminal 200 is a mobile communication terminal, such as a mobile telephone, a PDA, or a palmtop computer. Although the invention is not limited in this respect, the client terminal has limited computational resources and/or reduced user interface resources (such as display and input devices), compared to a full-size personal computer.

The exemplary client terminal 200 comprises an internal bus which interconnects a central processing device, a memory, a display adapter, and an input adapter. The internal elements of the client terminal have not been illustrated in the figures. The bus is also connected to a communication adapter that enables communication between the client terminal and the network 400. The communication adapter may be a GSM, GPRS, UMTS, CDMA, or PCS module, adapted for interoperability with the mobile communication subnetwork that is included in the network 400. Alternatively, the terminal 200 may be arranged to communicate with the network 400 by means of local wireless communication, such as WLAN. The display adapter is further connected to a display, and the input adapter is further connected to a user operated input device such as a keyboard. The central processing unit in the client terminal 200 is arranged to execute instructions embodied in a computer program retained in the memory.

The computer program in the memory particularly comprises a web browser program, which may be configured to provide the user with web browsing features by offloading memory-intensive processes to a proxy server, in particular the transcoding server 100.

Although the present invention is not limited in this respect, the browser may be a micro browser such as a Java application which is downloadable from another server connected to the network 400.

A possible task of the transcoding server 100 is to reformat web pages, i.e. markup language documents, fetched from servers, such as the web server 500, to a more compact representation than their original representation. An example is the Opera Binary Markup Language (OBML). As a part of the reformatting process, the content may be adapted for rendering on a small display screen.

Unlike a regular, full-size web browser applicable for a full-scale computer, the browser may be included in and executed by a compact client terminal 200 such as a mobile telephone, since it demands substantially less memory and computational resources.

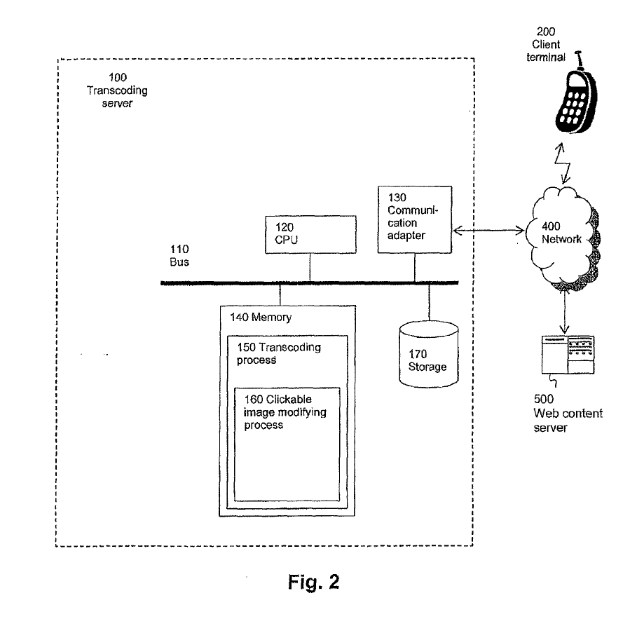

FIG. 2 is a block diagram illustrating a structural representation of a transcoding server in accordance with an embodiment of the invention.

The transcoding server 100 comprises an internal bus 110, which is connected to a central processing unit 120, arranged to execute instructions embodied in a computer program retained in the memory 140, which is also connected to the bus 110.

The bus 110 is also connected to a data storage 170, such as a magnetic medium, for non-volatile storage of programs and/or data.

The bus 110 is also connected to a communication adapter 130 which provides communication with the network 400. The communication adapter may be a high bandwidth network adapter.

In addition, the transcoding server may comprise additional devices (not illustrated), connected to the internal bus 110. Such additional devices include an output device such as a display adapter, which is further connected to a display, and an input adapter, which is connected to input devices such as a keyboard and a pointer device.

The computer program in the memory 140 particularly comprises a transcoding computer program module 150. The transcoding module 150 particularly comprises a clickable image modifying module 160.

The transcoding module 150 comprises computer program portions for accessing a requested resource or content, such as a markup language document, for instance a HTML document, from a web server 500 connected to the transcoding server 100 via the communications network 400.

The transcoding module 150 further comprises computer program portions for communicating with the client terminal 200 via the network 400.

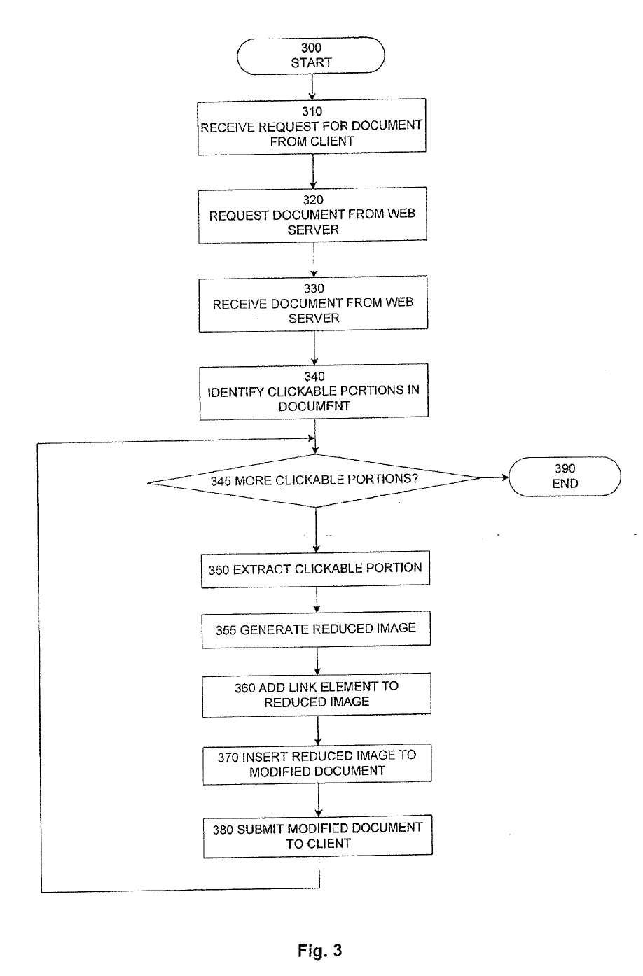

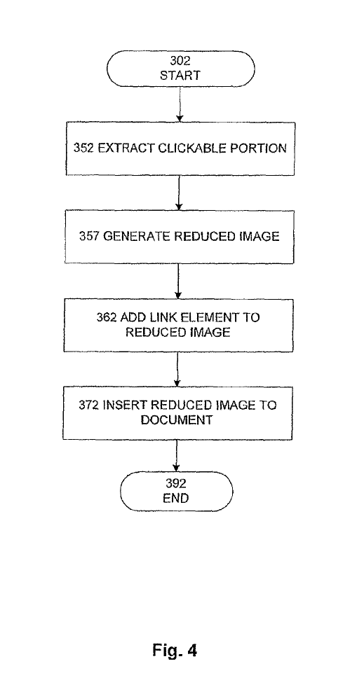

The transcoding module 150 is arranged to perform a method according to the invention, such as one of the embodiments being described in detail below with reference to FIG. 3 or 4.

FIG. 3 is an exemplary flow chart illustrating an embodiment of a method for modifying a markup language document which includes a clickable image, in accordance with the invention,

In the illustrated embodiment, it is assumed that the method is performed by a transcoding server, such as the transcoding server 100 illustrated above with reference to FIGS. 1 and 2.

The invention should, however, not be considered as limited in this respect. The method may thus alternatively be performed as a client process, e.g. as a part of a browser program included in and executed by a client terminal operating in a network, or the method may be performed as a server process, e.g. by a web server from which the markup language document originates.

In embodiments where the method is performed by a client computer or by a web server, the transcoding server may be an unessential element in the system, although the invention is not limited in this respect.

The exemplary method illustrated in FIG. 3 is performed by a transcoding server operating in a computer network, in interaction with a client terminal and a web server which are also operatively connected to the network. Consistent with the invention, the document is retrieved from the web server, and the modified document is submitted to a web browser in the client.

The method is a process for modifying a markup language document which includes a clickable image, and starts at the initial step 300.

First, in step 310, a request for a web document is received by the transcoding server 100, typically from an application program executed by the client terminal, such as the browser application executed by the client terminal 200.

Next, in step 320, the transcoding server 100 submits a request for the document to the web server 500. The document is a digital document coded in a markup language, such as a HTML, XML or XHTML document.

Next, in step 330, the transcoding server 100 receives the document from the web server 500.

Next, in step 340, clickable portions in the image map in the document are identified. If there is more than one clickable portion in the image map in the document, a plurality of clickable portions are identified. According to one embodiment, all clickable portions in the document are identified.

An image map in a HTML document may be identified by the ISMAP attribute, the USEMAP variable or the <map/> tag in the HTML document.

Consistent with one embodiment of the invention, the identifying step 340 comprises grouping clickable portions that have the same link address. This is useful in case an image map contains a plurality of portions that link to the same address. In this case one single image may be created, linking to the address that was associated with a plurality of image portions in the original document.

Next, in the determining step 345, the process determines if there are more clickable portions in the imagemap, i.e. if there are clickable portions that have not been modified by the process. If there is at least one more clickable portion in the imagemap, the process continues at the extracting step 350. Else the process terminates at the terminating step 390.

In the extracting step 350, a clickable portion of the clickable image is extracted from the unmodified document. The clickable portion is associated with an address, in particular a network link address, such as a URL. The clickable portion is also associated with a set of coordinates which defines the contour of the clickable portion. The extracting step may include the image extracting step known as cropping.

In the generating step 355, a reduced image corresponding to the extracted portion is generated.

Next, in the adding step 360, a link element is added to the reduced image. The link element has an address corresponding to the link address of the clickable portion.

Next, in the inserting step 370, the reduced image is inserted into the modified document.

In an embodiment consistent with the invention, the generating step 355 comprises creating an alpha-map representing the clickable portion by drawing it into an alpha image, and the inserting step 370 comprises pasting the clickable image using the alpha-map created in step 355.

In an embodiment consistent with the invention, the extracting step 355 comprises temporarily storing the clickable portion in a data file, and the inserting step 370 comprises inserting a reference to this data file in the modified document.

In an embodiment consistent with the invention, the inserting step comprises incorporating the clickable portion in the modified document as a data-URL.

In an embodiment consistent with the invention, a transparent area of the reduced image is cropped, i.e. removed from the reduced image.

Further consistent with the invention, all transparent areas of the reduced image is cropped, i.e. removed from the reduced image.

Next, in the submitting step 380, the modified document is submitted to the client computer through the network.

Then the process continues at the determining step 345.

The above embodiment of the method, as illustrated in FIG. 3, may be implemented by the skilled person as a computer program, which may be embodied as computer program instructions stored on a computer-readable medium or carried by a propagating signal. The computer program will, when loaded into the memory 130 in the transcoding server 100, cause the transcoding server 100 to perform the method according to the invention.

FIG. 4 is an exemplary flow chart illustrating another embodiment of a method in accordance with the invention.

The process illustrated in FIG. 4 may be considered as corresponding to a subset of the more specific process illustrated in FIG. 3 above.

The process in FIG. 4 may be performed by a transcoding server operating in the network. In this case, the document to be modified is retrieved from a web server operating in the network, and the modified document is submitted to a client terminal, in particular to a web browser client, operating in the network. Alternatively, the method may be performed by the client terminal operating in the network, in particular by a web browser included in the client. Alternatively, the method may be performed by a web server operating in the network. In the latter case, and consistent with one embodiment of the invention, the method is performed on request from a browser client operating in the network or as a result of information included in a request received from a client if said information identifies the client as one that requires modified image maps.

The method is a process for modifying a markup language document which includes a clickable image, and starts at the initial step 302.

Next, in the determining step 345, the process determines if there are more clickable portions in the imagemap, i.e. if there are clickable portions that have not been modified by the process. If there is at least one more clickable portion in the imagemap, the process continues at the extracting step 350. Else the process terminates at the terminating step 390.

Next, in the extracting step 352, it is assumed that there is a clickable portion in an imagemap included in the document. Therefore, in the extracting step 352, a clickable portion of the clickable image is extracted from the unmodified document. The clickable portion is associated with an address, in particular a network link address, such as a URL. The clickable portion is also associated with a set of coordinates which defines the contour of the clickable portion. The extracting step may include the image extracting step known as cropping.

Next, in the generating step 357, a reduced image corresponding to the extracted portion is generated.

Next, in the adding step 362, a link element is added to the reduced image. The link element has an address corresponding to the link address of the clickable portion.

Next, in the inserting step 372, the reduced image is inserted into the modified document.

In an embodiment consistent with the invention, the generating step 357 comprises creating an alpha-map representing the clickable portion by drawing it into an alpha image, and the inserting step 372 comprises pasting the clickable image using the alpha-map created in step 352.

In an embodiment consistent with the invention, the extracting step 357 comprises temporarily storing the clickable portion in a data file, and the inserting step 372 comprises inserting a reference to this data file in the modified document.

In an embodiment consistent with the invention, the inserting step 372 comprises incorporating the clickable portion in the modified document as a data-URL.

In an embodiment consistent with the invention, a transparent area of the reduced image is cropped, i.e. removed from the reduced image.

Further consistent with the invention, all transparent areas of the reduced image is cropped, i.e. removed from the reduced image.

The above embodiment of the method, as illustrated in FIG. 4, may be implemented by the skilled person as a computer program, which may be embodied as program instructions stored on a computer-readable medium or carried by a propagating signal. The computer program will, when loaded into the memory 130 in a computer such as a transcoding server, a client computer or a web server, cause the computer to perform the illustrated method.

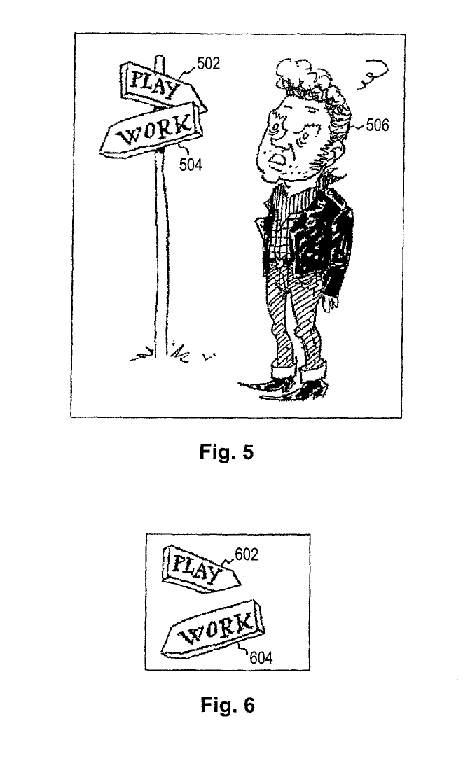

FIG. 5 is an exemplary screenshot, showing a markup language (HTML) document as viewed on a regular terminal, without modification.

The document includes an image, as illustrated, which is associated with an imagemap, i.e. a list of coordinates relating to the clickable portions 502 and 504 in the image. The coordinates are defined in order to establish links, i.e addresses/URLs of the portions 502, 504 to various target pages on the web.

The image also contain other image portions, such as the character 506, which is not associated with any particular link.

The image shown in FIG. 5 is appropriate for viewing on a regular, full-scale computer display. However, when viewing the document on a small-screen display, e.g. on a mobile telephone equipped with a web browser, it would be an advantage to reduce or remove the less essential information in the document.

FIG. 6 is an exemplary screenshot, showing the same HTML document, this time viewed on a small screen terminal, subsequent to a modification performed in accordance with the principles of the invention.

The clickable portions 502, 504 in the original document (FIG. 5) have thus been identified and extracted, and reduced images corresponding to the extracted portions have been generated. The links associated with the portions “PLAY” 502 and “WORK” 504 respectively, have been added to the reduced images. The reduced images appear as elements 602, 604 of the modified document as viewed on the small screen client terminal (e.g. a mobile telephone). The user is presented with a reduced display which still contains the most essential information of the original document, in particular the image map links and the image portions that were associated with the links.

The above detailed description of the invention has been presented for purposes of illustration. It is not exhaustive and does not limit the invention to the precise form disclosed. Modifications and variations are possible in light of the above teachings or may be acquired from the practicing of the invention.

1. Method for modifying a markup language document which includes a clickable image, the method comprising the steps of
extracting a clickable portion of the clickable image;
generating a reduced image corresponding to the extracted portion;
adding a link element to the reduced image, the link element having an address corresponding to the link address of the clickable portion; and
inserting the reduced image into the document.

2. Method according to claim 1, wherein the extracting step, the generating step, the inserting step and the adding step are repeated for a plurality of clickable portions identified in an imagemap in the document.

3. Method according to claim 2, further comprising the initial step of identifying the plurality of clickable portions in the imagemap in the document.

4. Method according to claim 3, wherein said plurality of clickable portions includes all clickable portions in the document.

5. Method according to claim 1, wherein said generating step comprises creating an alpha-map representing the clickable portion by drawing it into an alpha image.

6. Method according to claim 5, wherein said inserting step comprises pasting the clickable image using the alpha-map.

7. Method according to claim 1, wherein said extracting step comprises temporarily storing said clickable portion in a data file, and wherein said inserting step comprises inserting a reference to said data file in said document.

8. Method according to claim 1, wherein said inserting step comprises incorporating said clickable portion as a data-URL.

9. Method according to claim 1, further comprising cropping a transparent area of the reduced image.

10. Method according to claim 9, further comprising cropping all transparent areas of the reduced image.

11. Method according to claim 3, wherein said initial step of identifying the plurality of clickable portions in the imagemap in the document comprises grouping clickable portions with the same link address.

12. Method in a transcoding server for modifying a markup language document which includes a clickable image, the method comprising the steps of
receiving a request for a document from a client;
requesting said document from a web server;
receiving said document from a web server;
identifying at least one clickable portion of the clickable image in said document;
extracting a clickable portion of the clickable image;
generating a reduced image corresponding to the extracted portion;
adding a link element to the reduced image, the link element having an address corresponding to the link address of the clickable portion;
inserting the reduced image into the document; and
submitting the modified document to said client.

13. Method according to claim 1, wherein said link address is a URL.

14. Method according to claim 1, performed by a transcoding server operating in a computer network.

15. Method according to claim 14, wherein the document is retrieved from a web server in the computer network, and wherein the modified document is submitted to a web browser client operating in the computer network.

16. Method according to claim 1, performed by a browser client in a computer network.

17. Method according to claim 1, performed by a web server operating in a computer network.

18. Method according to claim 17, performed on request from a browser client operating in the computer network.

19. Computer program product, tangibly embodied in a memory, on a storage medium or on a propagated signal, comprising computer instructions that causes a computer to perform a method according to claim 1.

20. Computer device, configured to perform a method according to claim 1.

21. Transcoding server, web server or browser client, configured to perform a method according to claim 1.
